(19) United States
(12) Patent Application Publication
(10) Pub. No.: US 2009/0144552 A1
(43) Pub. Date: Jun. 4, 2009

(54) Method of Electronic Archiving, In Particular Remote Archiving, of Documents or Objects

(76) Inventor: Pierre Fort, Nimes (FR)

Correspondence Address: LADAS & PARRY LLP, 26 WEST 61ST STREET, NEW YORK, NY, 10023, US

(21) Appl. No.: 11/992,861

(22) PCT Filed: Feb. 6, 2007
(86) PCT No.: PCT/FR2007/000217

§ 371 Date: Mar. 28, 2008

(30) Foreign Application Priority Data
Feb. 8, 2006 (FR) 06 50449

(51) Int. Cl. H04N 1/44; G06F 12/14

(52) U.S. Cl. 713/178

(57) ABSTRACT

The invention relates to a method of electronic archiving, in particular remote archiving, of at least one document or object. The method is characterized in that it comprises the operations of creating a digital document of the document or object to be archived, of electronically signing the document and of sealing the document, with date-stamping, of creating a sealed envelope containing the document with the certificate of signing, of drawing up a certificate for the operation of creating the envelope and of transporting the envelope with its certificate to the place of archiving, of opening the envelope at this place, while checking the integrity of the envelope and the document and of archiving the latter on a long-duration medium for use with the elements proving the integrity of the document. The invention is usable for the archiving of documents or objects

The invention involves a remote electronic archiving process of at least a document or object (by digital object is understood an information object with intellectual content represented at the lowest level by a string of bits; it can also be represented by a coded and structured form).

At this time, there is no archiving process in existence performed in such a way that the authenticity and integrity of the archived documents or objects can be guaranteed.

The purpose of this invention is to remedy this lack or absence.

To reach this goal, the electronic archiving process according to the invention is distinctively defined in that it includes the operations for creating a digital document, the electronic signature of the documents, creation of a sealed envelope comprising at least an electronically signed documents, transfer of the sealed envelope to its storage location, with sealing key, from its original status defined by the author at the time of transmission, either as a result of a technical problem, or as a result of an encroachment of the original file by another one, for hostile purposes of opening the envelope with verification of the entire envelope and the document and of archiving the latter on a long-term use support, with document integrity elements of proof.

The invention will be better understood and other goals, features, details and advantage of the latter will appear more clearly in the explanation that will follow.

As an example of the implementation of the invention, hereinafter will be described in a detailed fashion, the various stages of the remote archiving process of a document by a person called creator, from the creation of this document until its archiving.

As such, a first step to be carried out by the creator who wishes to archive a document consists, after creating the digital version of the document to be archived, using a software of the type of Word, Excel, TXt, Image, Video, in writing a perennial format, namely a format independent of any technology change in time (material, software evolution), such as a format known by the name of PDF/A-1 and XML to guarantee the intelligibility of the digital archive in time (several tens or even hundreds of years).

The creator of the document enters it on his computer and assigns to the latter a descriptive comprising additional data called metadata that enable searching for it later on or qualifying it as such as well as contextual metadata that can bring the document back to its creation context, for instance, by specifying the legal qualification of the latter.

The format of these metadata could be a known format such as XML but could take on any other form, for instance, the one known by the names of CSV, TXT.

During the next step, the creator electronically signs the document as it has been established during step 1. The electronic signature permits to guarantee the identity and authorization or clearance of the creator, the integrity of the document, and via a Data and Time Third Party, the true date and hour of the signature. The validity of this signature is assured by the approved certification authority that had on a prior basis issued a signature right certificate to the creator. In other words, for that purpose, the creator must connect himself to the approved authority. If the certificate is considered valid, in other words not rejected in the usage context of the moment, the authority allows him to sign in, which excludes a subsequent invalidation of a validly given signature. The certification authority called Certifying Third Party as such checks for each signature, the creator right to use the signature. It must be pointed out that the Certifying Third Party is required to archive all of the usage events of a signature with its context specifying who has signed what and when, and which could subsequently constitute one of the elements of the probative value.

Please note that several operators can countersign the document of which one only is the creator, which will then be confirmed in the signature certificate. Several types of signature are supported whether they are internal or external to the document.

A third intermediary, as applicable, independent from the creator of the document and of the Certifying Third Party, in this case a Date and Time Third Party, is responsible for the evidence of the true date and time of the signature. During the signature process, the Certifying Third Party goes looking for a date and time token that confirms the true date and time for the document in question associated with its signature, with the Date and Time Third Party that must archive it.

To increase process security, the creator generates a seal that has the purpose of guaranteeing the integrity of the document contents, of the metadata and the signature. This content is called “data transfer”. Sealing of the data transfer is done by calculating a sealing key according to a hashing algorithm such as the algorithm known by the name of MD5, preferably different, for security reasons, of the one used at the time of the signature.

The next step is the creation of a secured envelope according to a program called “data transfer client agent.” This one processes the data transfer to generate this secured envelope.

This process consists of generating a file that will be added to the envelope and that describes its contents, in a detailed fashion. Then, the data transfer can be compressed to reduce the size of the envelope and make the content illegible to any person that does not have the proper algorithm.

Then the operator can proceed with the encryption of the file envelope with a special key, that is useful if the transfer line to the archiving location is not secured.

Then the envelope is sealed by computing a sealing key for instance according to the MD5 algorithm to ensure integrity of the envelope. As has been indicated above, sealing is a mathematical operation that generates a unique number computed with the contents of the envelope so that any modification, no matter how small, results in modifying the seal.

Finally, the creator constitutes the data transfer slip which is a summary of the contents of the envelope—name of the creator, data transfer service, referral, etc.) and of the context. This data transfer slip as well as the seal are prepared for transmittal to the archiving location in an isolated fashion which will permit checking its integrity and contents upon receiving the envelope.

Please note that the envelope can contain several documents, each of which is sealed.

The next step is that of transferring the envelope, the data transfer slip and the envelope seal, separately to its place of archiving using a transfer program via secured networks (for instance networks known by the name of VPN, SSL . . . ) up to the storage location.

At this location, upon receiving the envelope that constitutes the next step, a program called “receiving agent” checks the envelope sealing, in other words, its integrity by comparing the sealing key accompanying the envelope with the key calculated on location by using the same mathematical algorithm as at the time of sealing the envelope.

Then, the receiving agent opens the envelope and extracts each of the documents and checks them for integrity, thanks to the seal, as this was explained for the envelope, in other words, checks that the contents of the document(s) has not been intentionally or accidentally altered during the transfer. A check is made by the receiving agent, using the data transfer slip, of the complete nature of the envelope, in other words, he checks whether all of the components to be received have indeed been received.

Then, to formalize the taking on of responsibility by the receiving agent, namely the true date and time, a data and time token is requested by the receiving agent from a Date and Time Third Party, that may be independent, dealing at least with the envelope seal.

The next step, involves the secured storage and archiving of the data transfer(s). Each envelope document is classified by the archiving entity using the metadata that have been added to the document at the time of its preparation, so that one can search, consult the document and establish the associated authorizations or clearances.

Then, archiving takes place on an appropriate support such as a so-called WORM disk, in other words, an electronic support that can be read many times, but only written once, for instance of the type known by the name of CENTERA, NETAPP, HP SNAPLOCK, IBM DR550 . . . with the associated metadata, the features of the file, the duration of retention or the duration of administrative use, the type, the size, the signature certificate of the sender, the date and time certificate and the original seal. The WORM support is recommended but does not exclude other supports.

To consult the archived document, the requesting party makes the hook up to the remote archiving site (which can be within the organization or outside) and gives his identity by presenting his certificate of authorization or clearance established by his certification authority. Using this certificate, an eligibility check is made with a Certifying Third Party.

After approval by the latter, on the basis of the authorizations or clearances of the requesting party, the archiving entity enables the latter to make a search on the server. In response, he receives a list of documents with their metadata enabling him to validate either reading, or transmittal by mail or fax, or request a copy.

To ensure the mandatory traceability of the process, all operations such as data transfer, search, consultation, transmittal by mail, shall be recorded with the formal identification of the requesting party, the date and time of the request and will be finally archived.

To improve security even further during consultation, for the purpose of avoiding a disclosure of the conventional documents, the documents could be provided, according to the degree of confidentiality, with the addition of a digital watermark comprising the identity of the requesting party and the date and time of the consultation, which will then appear on all supports such as the screen, printing, email, etc.

From the description of the above invention, it appears that the latter proposes a process that permits:
to ensure that a document or object created by a user is transported, then stored, by guaranteeing its inviolability and its authenticity,
to know its creator with certainty, as well as the persons and processes that intervened in its establishment, transport and storage. In other words, the process permits to ensure in an undeniable manner, the authenticity of the document when it is restored after archiving with the original document, in a manner that can legally be proven. Please note that the process integrates the DUA notion (administrative use duration or retention time) transmitted by the metadata.

It appears from the description that the archiving process includes a plurality of cascading seals such as the sealing that can be contained in the electronic signature, the seal of the data transfer and the envelope seal, in other words, a combination of at least three levels of algorithms in cascade form. Please note that it is not the number of levels making up the cascade that is important but the principle itself of the sealing cascade that guarantees the security of the process thus ensuring the integrity of the documents, in a manner that can be legally proven.

Beneficially, the algorithms used during the sealing operations can be different, thereby increasing process security.

1. Remote electronic archiving process of at least a document or object, in that it includes the operations of creation of a digital version of the document or object to be archived, of an electronic signature of the document and sealing of the documents, with date and time indication, of the creation of a sealed envelope containing the document with the signature certificate, of the establishment of an operating certificate of creation of the envelope and transport of the envelope with its certificate to the location of archiving, of opening of the envelope at this location, with checking the integrity of the envelope and of the document and its archiving onto a long-term usage support with elements of evidence of document integrity.

2. Process according to claim 1, in that the digitized document is rewritten into a perennial format to guarantee intelligibility of the archiving.

3. Process according to claim 2, in that subsequent search and qualification metadata and contextual metadata are associated with the document.

4. Process according to claim 3, in that the signature operation of the document requires that the signing person has obtained in advance the authorization to sign from an approved authority and implies a check of the validity of this authorization by the approved certification authority.

5. Process according to claim 4, in that the approved certification authority is required to archive all of the usage events of a signature with its context.

6. Process according to claim 5, in that a date and time third party is required to date and time the document and archive the dating and timing.

7. Process according to claim 3, in that the operation creator of the archiving of the document generates a seal for the purpose of guaranteeing the integrity of the document contents, the metadata and the signature, called data transfer.

8. Process according to claim 1, in that the creation of the secured envelope implies the establishment of a file describing the contents of the envelope that is added to it.

9. Process according to claim 8, in that the envelope is sealed.

10. Process according to claim 8, in that the creation of the secured envelope implies compression of the data transfer.

11. Process according to claim 8, in that the envelope file is encrypted, such as, if the transfer line is not secured.

12. Process according to claim 7, in that a data transfer slip is prepared.

13. Process according to claim 12, in that the data transfer slip and the seal on the one hand and the envelope on the other hand, are sent separately to the location of archiving using a transfer program through a secured network.

14. Process according to claim 13, in that upon receiving the envelope a program checks the authenticity and integrity of the envelope and of its contents.

15. Process according to claim 14, in that the document with its different certificates is archived onto the long term support, together with the associated metadata, the features of the file, the signature certificate of the sender, the date and time and the seal.

16. Process according to claim 15, in that for consulting an archived document, the requesting party connects onto the archiving site and states his identity by presenting his authorization or clearance certificate.

17. Process according to claim 16, in that to ensure the traceability of the process, all involved operations are archived.

18. Process according to claim 7, in that it involves a cascading chain or sequence of a plurality of sealing operations such as sealing the electronic signature, sealing of the data transfer and sealing of the envelope.

19. Process according to claim 7, in that the transfer is processed by a data transfer client agent program to generate the secured envelope.
